(19) United States
(12) Patent Application Publication
(10) Pub. No.: US 2026/0356266 A1
(43) Pub. Date: Nov. 12, 2026

(54) VEHICLE DOOR ASSEMBLY

(71) Applicant: Re:Car Inc., Troy, MI (US)

(72) Inventors: Sandra Cun, El Monte, CA (US); Manasi Pore, Royal Oak, MI (US); William Jackson, Rockwall, TX (US); Aaron Gould, Grosse Pointe Park, MI (US); Chris Nichols, Detroit, MI (US); Kirill Ponomarenko, Huntington Woods, MI (US); Scott Anderson, Commerce Township, MI (US); Manal Makki, Dearborn Heights, MI (US)

(21) Appl. No.: 19/642,377

(22) Filed: Apr. 8, 2026

Related U.S. Application Data
(60) Provisional application No. 63/786,852, filed on Apr. 10, 2025.

(51) Int. Cl. B60N 2/75; B60J 5/04; B60N 3/10; B60R 7/04; B60R 13/02

(52) U.S. Cl. CPC B60N 2/787; B60J 5/0413; B60J 5/0468; B60N 2/78; B60N 3/103; B60R 7/046; B60R 13/0243

(57) ABSTRACT

A vehicle door assembly comprising one or more door panels including at least an inner door panel, a trim panel located on an inner side of the one or more door panels, a bolster, and an armrest. The armrest and/or the bolster is removable from the trim panel. The bolster and the armrest cooperate to define a handle.

### CROSS-REFERENCE TO RELATED APPLICATIONS

The present application claims benefit to U.S. Provisional Application No. 63/786,852, filed Apr. 10, 2025, which is incorporated herein by reference in its entirety.

### FIELD

The present teachings generally relate to door assemblies for a vehicle.

### BACKGROUND

Door assemblies for vehicles are typically fabricated from a complex arrangement of parts. Moreover, door panels are provided with design and functional features that are integrally formed to the door panels, or at least connected in a manner that separation of the parts would result in destruction or plastic deformation thereof. Generally, there are limited options for modularity, customizable accessories, and customizable cosmetics.

It would be desirable to provide a vehicle door assembly with components that can be removed and swapped for other components without destruction or plastic deformation thereof.

### SUMMARY

The present disclosure relates to a vehicle door assembly and a vehicle comprising the same, which may address at least some of the needs identified above.

The vehicle door assembly may comprise one or more door panels including at least an inner door panel, a trim panel located on an inner side of the one or more door panels, a bolster, and an armrest. The armrest and/or the bolster may be removable from the trim panel. The bolster and the armrest may cooperate to define a handle.

The bolster and the armrest may be removable from the trim panel and/or from each other without destruction or plastic deformation of the trim panel, the bolster, and the armrest.

The bolster and the armrest may be connected to the trim panel and/or an inner door panel via first fasteners.

The first fasteners may include elastically deformable fasteners. The elastically deformable fasteners may include push-in rivet style fasteners, cantilever snap-fit fasteners, or both.

The first fasteners may be integrally formed to the bolster, the armrest, or both.

The trim panel, the bolster, the armrest, or any combination thereof may be connected to the inner door panel via one or more second fasteners. The one or more second fasteners may include screws, bolts, or both.

The one or more second fasteners may be located in a region of the bolster covered by the armrest, in a region of the armrest covered by portion of the armrest, or both.

The handle may be in the form of a pull cup.

The bolster may comprise one or more stand-offs, preferably two stand-offs, upon which the armrest may be supported. The handle may be defined between the bolster, the armrest, and the two stand-offs.

The bolster may include a depression defined in an A-side of the bolster (e.g., a concavity).

The bolster may cover an access opening in the inner door panel of the vehicle door assembly.

The armrest may comprise an inner portion and an outer portion. The inner portion may connect to the trim panel and/or the inner door panel via the first and/or second fasteners, preferably at least to the inner door panel with at least one of the second fasteners. The outer portion may connect to the inner portion via the first fasteners. The outer portion may be removable from the inner portion without destruction or plastic deformation of the inner and outer portions.

The outer portion may be defined by a thickness of about 1 millimeters (mm) to about 5 mm, more preferably about 2 mm to about 3 mm.

The outer portion may include one or more ribs.

The one or more ribs may be in the form of a honeycomb structure.

The bolster may be fabricated from a polymer. The polymer may include ABS, nylon, or both. The polymer may be fiber reinforced.

The armrest may be fabricated from a polymer. The polymer may include ABS, nylon, or both. The polymer may be fiber reinforced.

The present disclosure relates to a vehicle door assembly and a vehicle comprising the same, which may address at least some of the needs identified above.

The vehicle door assembly may comprise one or more door panels including at least an inner door panel, a trim panel located on an inner side of the one or more door panels, and a storage accessory removably connected to the inner door panel, a bracket, or a rail (e.g., a T-slot rail) connected to the inner door panel.

The storage accessory may be connected to the inner door panel via one or more fasteners (e.g., screws and/or bolts); or the bracket may be connected to the inner door panel via one or more fasteners (e.g., screws and/or bolts); or the rail (e.g., a T-slot rail) may be connected to the inner door panel via one or more fasteners (e.g., screws and/or bolts).

The one or more fasteners may pass through the storage accessory, bracket, or rail and through the trim panel and engage the inner door panel. A head of the fastener may be exposed.

The inner door panel may include at least two, or more preferably at least four mounting points for said one or more fasteners.

The at least four mounting points may be arranged in a first row and a second row. The second row may be below the first row.

The mounting points in the first row may be horizontally aligned. The mounting points in the second row may be horizontally aligned. Pairs of mounting points in the first and second rows may be vertically aligned.

The one or more storage accessories may be in the form of a cup holder or a door caddy.

The vehicle door assembly may comprise the bolster and armrest, and the storage accessory in accordance with one or any combination of the foregoing paragraphs.

### BRIEF DESCRIPTIONS OF THE DRAWINGS

FIG. 1A is a plan view of a vehicle door assembly according to the present teachings.

FIG. 1B is a plan view of a vehicle door assembly according to the present teachings.

FIG. 2A is a plan view of a vehicle door assembly according to the present teachings.

FIG. 2B is a perspective view of a vehicle door assembly according to the present teachings.

FIG. 2C is a perspective view of a vehicle door assembly according to the present teachings.

FIG. 3 is a plan view of a vehicle door assembly according to the present teachings.

FIG. 4A is a perspective view of a bolster according to the present teachings.

FIG. 4B is a perspective view of a bolster according to the present teachings.

FIG. 5A is a perspective view of an armrest according to the present teachings.

FIG. 5B is an exploded view of an armrest according to the present teachings.

FIG. 5C is an exploded view of an armrest according to the present teachings.

FIG. 5D is an exploded view of an armrest according to the present teachings.

FIG. 6A is a plan view of a vehicle door assembly according to the present teachings.

FIG. 6B is a plan view of a vehicle door assembly according to the present teachings.

FIG. 6C is a perspective view of a vehicle door assembly according to the present teachings.

FIG. 7 is a perspective view of a vehicle door assembly according to the present teachings.

FIG. 8 is a perspective view of a vehicle door assembly according to the present teachings.

FIG. 9A is a perspective view of a vehicle door assembly according to the present teachings.

FIG. 9B is a perspective view of a vehicle door assembly according to the present teachings.

FIG. 10 is a perspective view of a vehicle door assembly according to the present teachings.

FIG. 11 is a perspective view of a window crank according to the present teachings.

FIG. 12A is a plan view of a cup holder according to the present teachings.

FIG. 12B is a perspective view of a cup holder according to the present teachings.

FIG. 12C is a perspective view of a cup holder according to the present teachings.

FIG. 12D is a perspective view of a cup holder according to the present teachings.

FIG. 12E is a perspective view of a cup holder according to the present teachings.

FIG. 12F is a perspective view of a cup holder according to the present teachings.

### DETAILED DESCRIPTION

The description herein pertains to automotive vehicles. Preferably, it pertains to a vehicle that can be reconfigured from a first vehicle configuration to a second vehicle configuration. The vehicle can be reconfigured back to the first vehicle configuration. In other words, the vehicle has a reversible configurable structure.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a truck or pickup truck configuration. In the context of the present description, the other vehicle configuration (e.g., first vehicle configuration or second vehicle configuration) may be a sport utility vehicle (SUV) configuration.

In the context of the present description, a “pickup truck” includes a vehicle that may be a light, medium-duty, or heavy-duty truck. The pickup truck configuration may include a vehicle having an enclosed cab, cockpit, or occupant compartment (for at least a driver and at least one other occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

In the context of the present description, a “sport utility vehicle” includes a vehicle that may be a light, medium-duty or heavy-duty vehicle including an enclosed cab (for at least a driver and at least one and preferably a plurality of other occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added.

The vehicle in accordance with the present teachings (e.g., pickup truck configuration; SUV configuration, or any other configuration) may include a suspension. The suspension may include a solid axle. The suspension may include a de Dion suspension or axle. The suspension may include coil springs. The coil springs may be located forward or rearward of the solid axle and not on the axle. he suspension may be free of any leaf springs. The suspension may include one or more end plates that are integrally formed with the solid axle. The suspension may include a half shaft that extends from the one or more motors through an opening in the end plate.

The vehicle may include a front wheel drive system, a rear wheel drive system, or a combination of front and rear wheel drive (e.g., all-wheel drive system). As part of the reconfiguration, the vehicle may be converted from a rear wheel drive system to a wrong wheel drive system and/or to an all-wheel drive system.

The vehicle disclosed herein may be powered by an electrified powertrain (e.g., it is free of an internal combustion engine). An electrified powertrain may comprise one or more batteries. The one or more batteries may be chargeable by plugging the vehicle into a charging station and/or with regenerative features while the vehicle is in operation. The vehicle may include one or more wheel corner assemblies that include regenerative braking systems. The vehicle may include a front-wheel drive powertrain, a rear-wheel drive powertrain, or an all-wheel drive powertrain. A factory model of the vehicle may include rear-wheel drive or front-wheel drive, and an end user may install an additional motor or powertrain in the vehicle to convert the vehicle into all-wheel drive. The vehicle may comprise one or more motors, hardware, and/or software that allows for a plug-and-play integration when the powertrain is added or converted from front-wheel drive to rear-wheel drive and/or all-wheel drive, or from rear-wheel drive to front-wheel drive and/or all-wheel drive.

### Vehicle Door Assembly

The vehicle door assembly may comprise one or more door panels. The one or more door panels may function to define the structure of the door, contain electronic and/or mechanical mechanisms operable relative to the door, or both.

The electronic and/or mechanical mechanisms may include, but are not limited to, a window regulator, an electronic window regulator control, a mechanical window regulator control, a lock mechanism, a latch mechanism, one or more speaker units, one or more wires, one or more mechanical linkages, or any combination thereof.

The one or more door panels may include an outer panel and an inner panel. The outer panel may be oriented outward from a centerline of a vehicle. The inner panel may be oriented inward toward a centerline of a vehicle. The inner and outer panels may be fastened together. The inner and outer panels may be fastened by welding, mechanical fastening, chemical fastening, or any combination thereof. Mechanical fastening may include fasteners such as rivets, screws, bolts, folded edge(s), or any combination thereof. Folded edges may refer to, e.g., folding one or more edges of an outer panel over one or more edges of an inner panel.

In some exemplary aspects the one or more door panels may be monolithic in construction. That is, a door panel may comprise an inner portion and an outer portion monolithically formed.

The present teachings contemplate that the inner panels/portions may comprise one or more segments; and/or the outer panels/portions may comprise one or more segments. The one or more segments may be separable from each other. The one or more segments may be fastened to each other.

The one or more door panels may comprise a cavity. The cavity may be defined between an inner panel and an outer panel. The cavity may be defined between an inner portion and an outer portion. One or more electronic and/or mechanical mechanisms may be located in the cavity. Other elements of the vehicle door assembly may be located within the cavity as will be appreciated by the present teachings and their context. For example, one or more reinforcements may be located in the cavity. The one or more reinforcements may be functional in a collision of the vehicle. As another example, noise, vibration, and harshness (NVH) elements such as sound-dampening foam may be located in the cavity.

The present teachings contemplate that the inner panels may comprise one or more segments. The one or more segments may be separable from each other. The one or more segments may be fastened to each other.

The one or more door panels may be fabricated from metal. The metal may be selected from steel, aluminum, or both. The metal may be formed at least in part by stamping.

The one or more door panels may be fabricated from a composite. The composite may comprise a laminated and/or impregnated structure of one or more polymers, one or more metals, one or more textiles (e.g., comprising aramid fibers, mineral fibers, carbon fibers, or both), or any combination thereof.

The vehicle door assembly may comprise one or more cover panels. The one or more cover panels may be located onto the outer panel/portion. The one or more cover panels may function to provide a surface for paint, a vehicle wrap, or the like.

The vehicle door assembly may comprise one or more trim panels. The one or more trim panels may be located onto the inner panel/portion. The one or more trim panels may function to accommodate one or more accessories described herein, provide a comfort surface for an occupant to rest their body (e.g., an arm) upon, or both. The one or more trim panels may be adapted and configured, at least in part, to be a decorative surface of the occupant compartment.

The one or more trim panels may be fastened to an inner panel. The one or more trim panels may be fastened via elastically deformable fasteners. In this regard, the one or more trim panels may be removable from the inner panel. Typically, a trim panel may be removed for access into the vehicle door assembly to service and/or replace electronic and/or mechanical mechanisms.

Elastically deformable fasteners, as referred to herein with respect to at least trim panels, bolsters, and armrests, may mean fasteners that elastically deform during the joining of two elements or the separation of two elements. In this regard, at a first time, just prior to joining two elements, a portion of an elastically deformable fastener may be defined by a first dimension or deflection; at a second time, while the elastically deformable fastener of an element is being engaged with the other element (e.g., passing through a through-hole), the portion of the elastically deformable fastener may be defined by a second dimension or deflection; and at a third time, after the elastically deformable fastener has fully engaged with the other element (e.g., said portion has passed through and beyond the through-hole), the portion of the elastically deformable fastener may be defined by the first dimension or deflection, or a fourth dimension deflection that is less than the first dimension or deflection and greater than the second dimension deflection. By way of example, said dimension may be a diameter, e.g., of a rib of a ribbed fastener. By way of example, a deflection of a cantilever relative to the position of the cantilever with no forces acting upon it.

Elastically deformable fasteners may be separable from a fastening connection without destruction or plastic deformation thereof. Although, the present teachings contemplate that the elastically deformable fasteners may have a service life. So, elastically deformable fasteners may be separable from a fastening connection without destruction or plastic deformation thereof during their service life. That is, the present teachings contemplate that the fasteners may not be perfectly elastically deformable and that some degree of plastic deformation may occur, and the material may be fatigued over its service life. The service life may be characterized by a quantity of use cycles. Each instance of joining and separation of elements via the fasteners may be a cycle. By way of example, the service life may be about 20 to about 1000 cycles, about 50 to 950, about 100 to 900, about 150 to 850, about 200 to about 800, about 250 to about 750, or about 300 to about 700.

The elastically deformable fasteners may be separable from a fastening connection by a requisite pulling force to elastically deform the fastener to cause it to change in one or more dimensions and/or deflections to separate joined elements. The trim panel, the bolster, the armrest, or any combination thereof may comprise one or more access holes proximate to a fastener connection to allow a tool to be inserted to manipulate a fastener to separate joined elements. A combination of the foregoing approaches may be utilized.

Some or all of the elastically deformable fasteners may be structurally discrete. In this regard, the fasteners may include a shank and a head, whereby the shank may extend through elements being joined and the head remains exposed on a surface of the outermost element. Some or all of the elastically deformable fasteners may be integrally formed to the trim panel, the bolster, the armrest, or any combination thereof. In this regard, there may be no exposed portion of the fastener on a surface of the outermost element. A combination of the foregoing approaches may be utilized. Preferably, the fasteners may be integrally formed to the trim panel, the bolster, the armrest, or any combination thereof. The fasteners may be integrally formed to a B-side of the trim panel, the bolster, the armrest, or any combination thereof.

A-side and B-side may be referred to herein with respect to the orientations of opposing sides of elements, particularly the trim panel, the bolster, and the armrest. A-side may mean oriented toward an occupant compartment (e.g., toward a centerline of a vehicle). B-side may mean oriented away from the occupant compartment (e.g., away from a centerline of a vehicle). The A-side may be in opposing orientation to the B-side. An A-side of an outermost element may be visible within the occupant compartment. The B-sides of elements may not be visible within the occupant compartment.

Exemplary elastically deformable fasteners may include push-in rivet style fasteners, cantilever snap-fit fasteners, or any combination thereof. The push-in rivet style fasteners may have a shank in the form of an arrow, a shank in the form of a keyhole, a shank in the form of a pin lock, a shank that is ribbed, a shank that is solid, or a shank that is split. The present teachings contemplate that the push-in rivet style fasteners may be structurally discrete, as described above, or may be integral to an element (e.g., in the form of the shank extending from the element, and absent a head). The cantilever snap-fit fasteners may include a cantilever and a male (e.g., a hook) or female (e.g., a groove or cutout) element at the end of the cantilever.

The elastically deformable fastener may include a chamfered or radiused pull-out edge. This feature may aid in separating two elements by providing a surface for one element to slide along the fastener during separation. By way of example but not limitation, the barb portion of a hook on a cantilever may include a chamfered or radiused edge.

Some of the elastically deformable fasteners described herein may be referred to as snap-fit fasteners. That is, a portion that elastically deforms may pass beyond an edge, cease contact with surrounding structure influencing a change in one or more dimensions or deflection of the fastener, and snap into engagement. Although, the present etchings contemplate other fasteners that may not form a snap-fit, such as a push-in rivet style fastener in the form of an arrow.

Elastically deformable fasteners may be beneficial for the vehicle door assembly of the present teachings, to eliminate or at least minimize the appearance of fasteners on the A-side of the vehicle door assembly. In this regard, the surfaces of the vehicle door assembly may appear seamless.

The present teachings do not foreclose the use of other types of fasteners including screws, bolts, rivets, chemical fastening, magnets, or any combination thereof. Use of fasteners that may have an exposed head may be appropriate in regions covered by structural elements described herein. By way of example, a screw may be used to fasten a bolster to an inner door panel in a region where the bolster is covered by the armrest. By way of another example, a screw may be used to fasten an armrest to an inner door panel in a region where an inner portion of the armrest is covered by an outer portion of the armrest.

Screws or bolts may may be used to fasten the trim panel, the bolster, the armrest, or any combination thereof to an inner door panel. In this regard, the inner door panel may be fabricated from a rigid material such as a metal or a composite. Thus, the inner door panel may provide rigid mounting points for the trim panel, the bolster, the armrest, or any combination thereof, which may be comparatively less rigid than the inner door panel.

The vehicle door assembly may comprise one or more mating features to receive the fasteners. The mating features may be in the form of holes, edges, protrusions, or any combination thereof. The one or more holes may be through-holes, blind holes, or any combination thereof. The mating features may be located complementary to fasteners. That is, for example, a mating feature in a trim panel may be adapted and configured to align with a fastener of a bolster.

Some fasteners described herein may engage with one or more edges of a structural element. For example, an outer portion of an armrest may include cantilever snap-fit fasteners that engage with an edge of an inner portion of an armrest.

Some fasteners described herein may engage with one or more protrusions of a structural element. For example, a cantilever snap-fit fastener may engage with a protrusion with an edge, a groove, a cutout, or the like.

The illustrations of the present application are intended to be exemplary and not limiting. It is contemplated that the positions of the fasteners and mating features in the illustrated examples may be swapped. For example, where a hole is depicted on a trim panel and a corresponding fastener is depicted on an armrest, the present teachings contemplate the positions may be swapped such that the fastener is located on the trim panel and the hole is located on the armrest.

The present teachings contemplate that a fastener may engage with and/or extend through one or more structural elements described herein. By way of example, a fastener of an armrest may extend through a bolster, a trim panel, an inner door panel, or any combination thereof. By way of another example, a fastener of a bolster may extend through a trim panel, an inner door panel, or both. In some aspects, engagement of a fastener with an inner door panel may be preferable, for more rigid engagement.

The vehicle door assembly may comprise one or more bolsters. The bolster may function to cover an access hole in the trim panel, at least partially define a handle, both. The bolster may cover an access hole that may be provided for access into the cavity of the vehicle door assembly. Typically, this may be done for service or replacement of electronic and/or mechanical mechanisms described herein. Additionally, the access hole and the bolster may be located to cooperate with the armrest of the present teachings to define a handle. The bolster may also be decorative and/or comprise one or more cushioning layers (e.g., foam, gel, batting, or the like) for comfort.

The bolsters may be located between a trim panel and an armrest. The bolsters may be fastened to the trim panel, an inner door panel, or both. The bolsters may be fastened via the fasteners (e.g., elastically deformable fasteners, screws, and/or bolts) described herein.

The bolster may have one or more depressions formed thereon. The one or more depressions may cooperate with stand-offs, the armrest, or both to define a handle. The one or more depressions may be in the form of a groove, a concavity, or the like. The one or more depressions may be defined on the A-side of the bolster. That is, for example, the A-side may be concave or may have one or more grooves defined therein.

The bolster may comprise one or more stand-offs. The bolster may comprise preferably two stand-offs. The stand-offs may function as mounting surfaces for the armrest; to cooperate with the depression, the armrest, or both to define a handle; or both. The mounting surfaces may provide for a gap between a surface of the depression of the bolster and a B-side of the armrest. The stand-offs may be located on and/or proximate to a lower edge of the bolster. The stand-offs may comprise one or more fasteners, one or more holes, or both. The stand-offs may be in the form of posts or wedges.

The vehicle door assembly may comprise one or more armrests. The armrest may function as an armrest for an occupant, to define a handle of the vehicle door assembly, or both. The armrest may also be decorative and/or comprise one or more cushioning layers (e.g., foam, gel, batting, or the like) for comfort. The armrest may be located over at least a portion of the bolster. The armrest may be fastened to the bolster, the trim panel, the inner door panel, or any combination thereof. The armrest may be fastened via the fasteners (e.g., elastically deformable fasteners, screws, and/or bolts) described herein.

The armrest may comprise an inner portion and an outer portion. The inner portion may define the structure of the armrest. The outer portion may function as a cosmetic layer. The outer portion may cover fasteners exposed on the inner portion. The outer portion may be fastened to the inner portion via one or more fasteners (e.g., elastically deformable fasteners) described herein.

The vehicle door assembly may comprise a storage accessory. The storage accessory may be removably connected to the inner door panel. The storage accessory may be connected to a bracket or a rail that is connected to the inner door panel. The rail may be in the form of a T-slot rail. The storage accessories may be in the form of a cup holder or a door caddy.

The storage accessory, the bracket, or the rail may be connected to the inner door panel via one or more fasteners. The fasteners may include screws, bolts, or both. The one or more fasteners may pass through the storage accessory, bracket, or rail and through the trim panel and engage the inner door panel. The head of the fastener may be exposed.

The inner door panel may include at least two, or more preferably at least four mounting points for said one or more fasteners. The at least four mounting points may be arranged in a first row and a second row. The second row may be below the first row. The mounting points in the first row may be horizontally aligned. The mounting points in the second row may be horizontally aligned. Pairs of mounting points in the first and second rows may be vertically aligned.

The one or more wraps or wrap sheets may be made of one or more materials that are resistant to sunlight (UV), temperature, humidity, and/or salt-spray. The one or more wraps or wrap sheets may be made of a material that is generally scratch resistant and/or self-healing. “Self-healing” refers to the ability to return to an original appearance after being deformed, such as due to scratching or abrasion. The one or more wraps or wrap sheets may include a polymeric layer configured with micro-channels for enabling escape of trapped air during installation (and thus avoiding bubble formation).

The outer door panel may have a wrap or wrap sheet applied thereto. The wrap may be applied to any portion, any combination of portions, or to the entirety of the outer door panel, including but not limited to the bolster, the armrest, etc. The one or more wraps or wrap sheets may be made of one or more polymeric materials. The one or more polymeric materials may be derived from the polymerization of monomers containing a vinyl group (H2C═CH−). The one or more polymeric materials may be derived from an olefin, e.g., an α-olefin. The one or more polymeric materials may be halogenated, free of halogenation. The one or more polymeric materials may be a urethane derived material (e.g., a material derived from a reaction of an isocyanate with a polyol). Examples of suitable materials include polyvinyl chloride, thermoplastic polyurethane (e.g., and aliphatic thermoplastic polyurethane). The one or more polymeric materials may be or may comprise an acrylic. Examples of other polymers that may be suitable for use as a layer in the wrap or wrap sheet of the present teachings include a polyester such as a polyethylene terephthalate, a polyimide, and/or a polycarbonate; and the like.

The one or more wraps or wrap sheets may have an A-side that carries a decorative element. The A-side may face outwardly or away from the outer door panel substrate, and may display one or more pictures, images, patterns, designs, colors, logos, fonts, letters, numbers, marketing materials, political materials, or a combination thereof.

The one or more wraps or wrap sheets may be over-laminated or clear coated with a UV screen print clear layer over or on top of the A-side.

The one or more wraps or wrap sheets may have a B-side. The B-side may face towards the door panel substrate. The B-side may be in contact with the outer panel substrate, e.g., indirectly through the adhesive. Additionally, or alternatively, the B-side may be in contact with a previously applied wrap or wrap sheet.

The B-side may comprise one or more adhesives to attach or connect the one or more wraps or wrap sheets to the door panel substrate. The adhesive may be a high-tack adhesive that is configured for adhesion to glossy and matte finished protective clear coats, powder-coated paints, low surface energy plastics and fiberglass, or a combination thereof. The adhesive may include a pressure-sensitive adhesive and/or a high-tack adhesive.

The adhesive or adhesive layer may be covered or protected by one or more release layers, such as one or more carriers, foils, or backings that must be removed to expose the adhesive. A release layer may be a low friction or energy material that is easily removed or separatable from the adhesive or back side of the polymeric layer to expose the adhesive layer. Other adhesive systems may be employed including but not limited to adhesives based upon vinyl acetate, rubbers, and/or silicones.

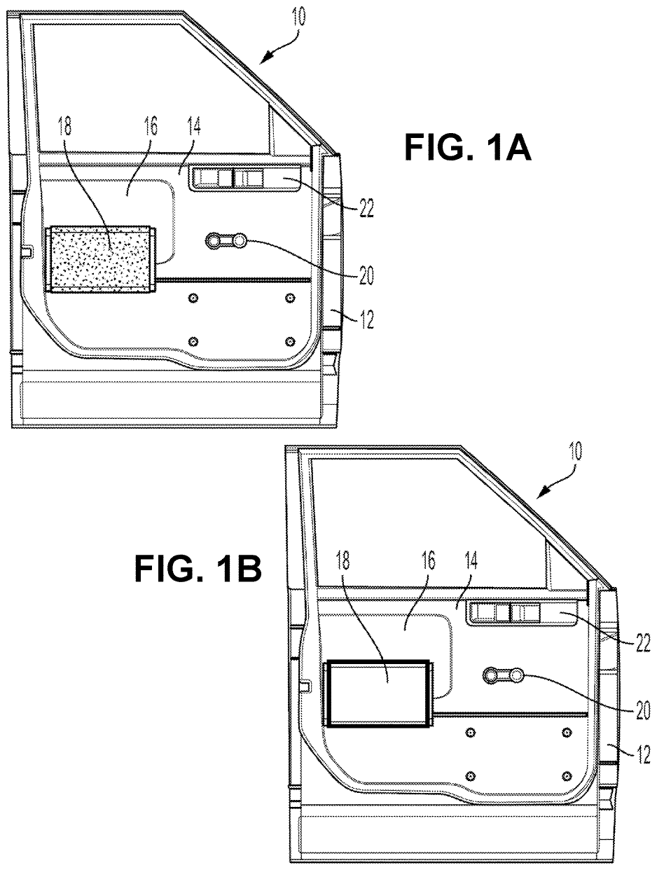

FIG. 1A and FIG. 1B illustrate a door assembly 10 comprising an inner door panel 12, an opposing outer door panel (not shown), a trim panel 14, a bolster 16, and an armrest 18. As can be seen by comparison of FIG. 1A and FIG. 1B, the bolster 16 and the armrest 18 are modular and can be swapped-out by users without the need for specialized tools or knowledge. The bolster 16 and the armrest 18 are removable from the inner door panel 14 and/or the trim panel 14 without destruction or plastic deformation of the bolster 16 and the armrest 18.

Other modular aspects of the door assembly 10, which may be appreciated by the present teachings include a window crank 20 and a door latch and lock assembly 22.

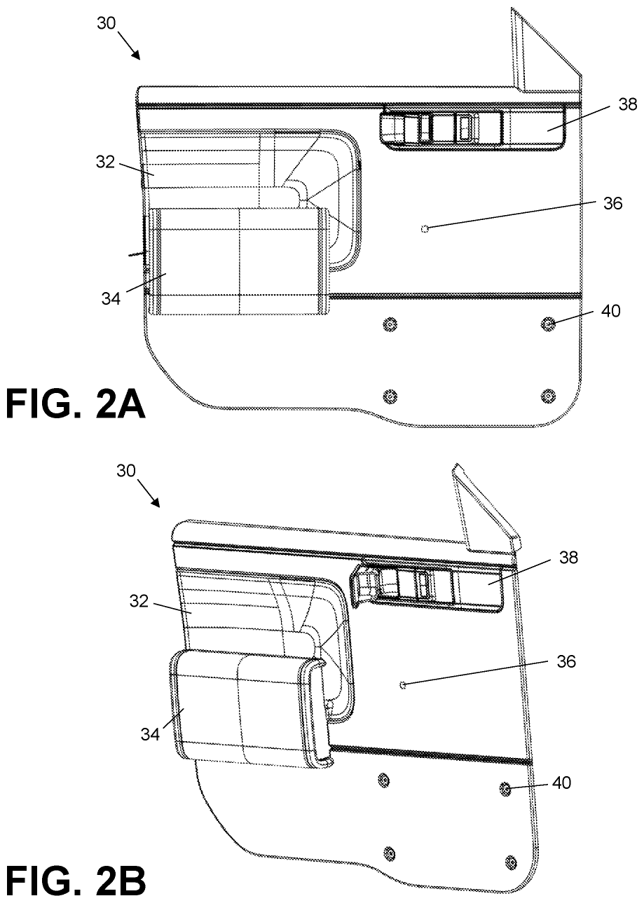

FIG. 2A through FIG. 2C illustrate an exemplary trim panel 30 comprising a bolster 32 and an armrest 34. The bolster 32 has a concavity relative to a surface of the trim panel 30 that is adapted and configured to orient toward an occupant compartment of a vehicle (e.g., toward vehicle occupants).

The trim panel 30 further comprises a hole 36 to accommodate mounting of a window crank (not shown). In this regard, a portion of the window crank extends through the hole and engages with a window regulator mechanism located between the inner and outer door panels.

The trim panel 30 further comprises a door latch and lock assembly 38. The door latch and lock assembly 38 comprises a door latch handle, a lock module, and optionally a power window module. As described herein, the vehicle door assembly is adapted and configured to be modular, to provide the owner various feature options both for personal preference and the ability to minimize vehicle cost by permitting the selection of basic options. For example, the door latch and lock assembly 38 can include manual lock controls or power lock controls; the door latch and lock assembly 38 can include power window controls or may be free of window controls where a window crank may be relied upon; or a combination of the foregoing features may be utilized. Various cosmetic options may also be available.

The trim panel 30 further comprises holes 40 which provide access to mounting points in the inner door panel. Thus, fasteners (not shown) pass through the holes 40 and into the inner door panel. The fasteners are used to mount storage accessories to the door assembly.

It is contemplated that the door assembly may comprise one or more speaker units (not shown). The trim panel 30 may include a cutout that is selectively covered, or covered by one or more acoustically transparent materials, such as a perforated rigid polymer, a mesh fabric, or both. The speaker units may be mountable to the inner door panel.

The trim panel 30 comprises a plurality of fasteners 42 on a B-side thereof. The fasteners 42 are adapted and configured to connect the trim panel 30 to an inner door panel.

FIG. 2A and FIG. 2B illustrate an A-side of the trim panel 30 and FIG. 2C illustrates a B-side of the trim panel 30.

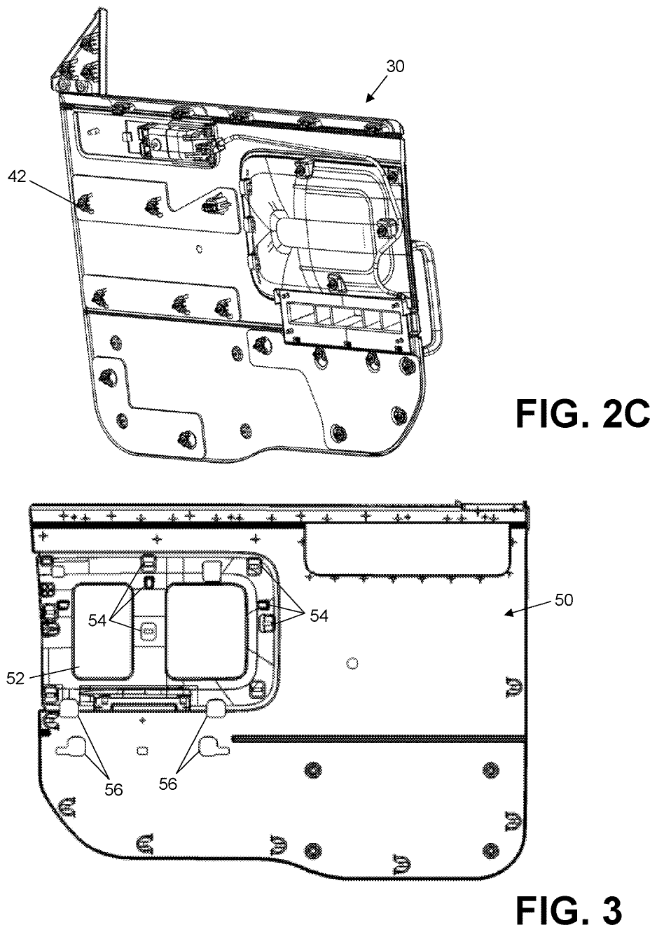

FIG. 3 illustrates a B-side of an exemplary trim panel 50. It can be seen that the bolster locates over and covers access holes 52 formed in the trim panel 50, which can be used to access the cavity defined between inner and outer door panels. The trim panel 50 includes a plurality of holes 54 that receive fasteners of a bolster, and a plurality of holes 56 that receive fasteners of an armrest.

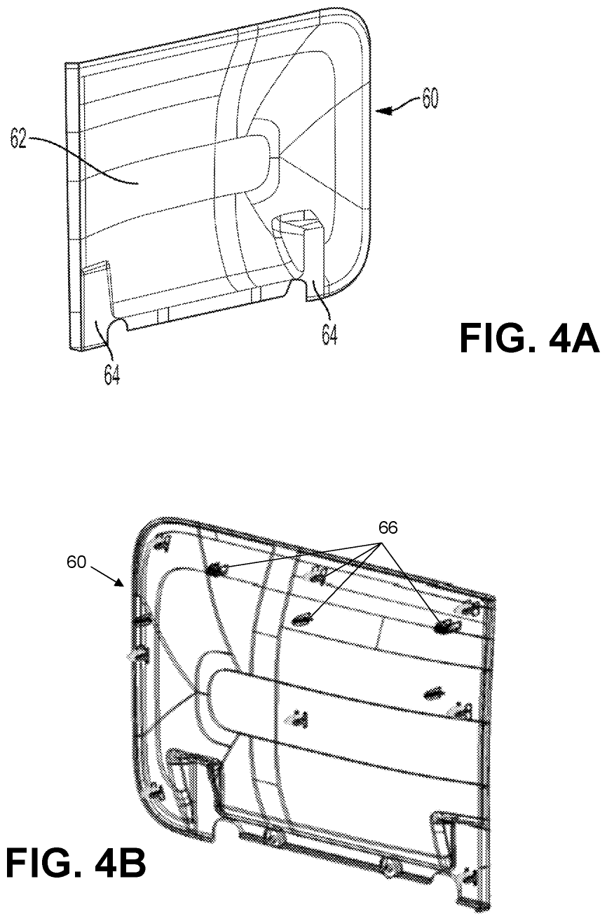

FIG. 4A and FIG. 4B illustrate an exemplary bolster 60. The bolster 60 includes a concavity 62 and two stand-offs 64. In this regard, the stand-offs 64 are adapted and configured as a mounting surface for an armrest, and a space is defined between the concavity 62, the stand-offs 64, and the armrest to form a handle by which a user can manipulate the vehicle door assembly. A B-side of the bolster 60 comprises a plurality of fasteners 66, which connect to a trim panel.

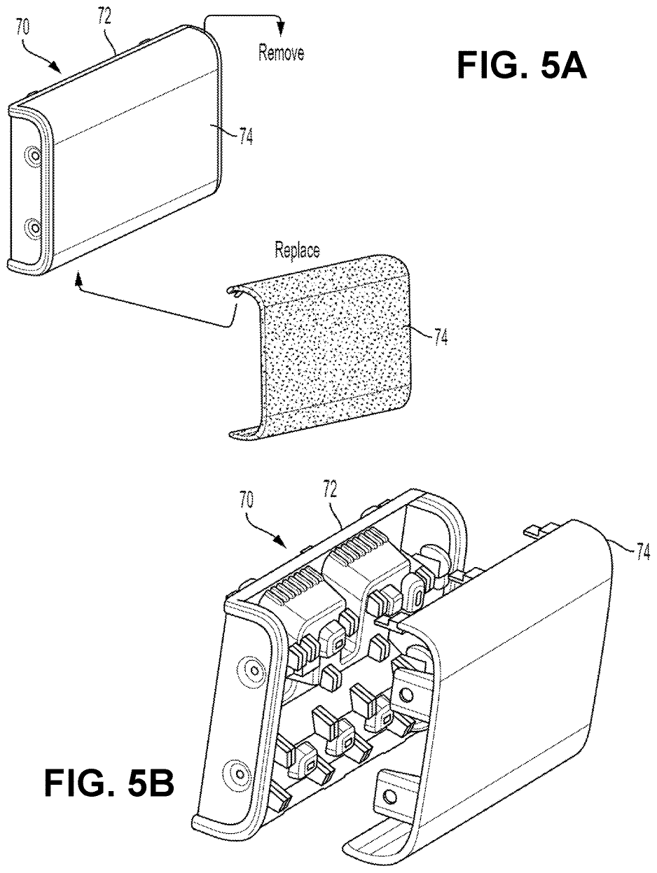

FIG. 5A through FIG. 5D illustrate an exemplary armrest 70. The armrest 70 comprises an inner portion 72 and an outer portion 74. The outer portion 74 is adapted and configured to be replaceable, such that different materials can be applied to the inner portion 72 to customize the cosmetics thereof. The outer portion 74 can be replaceable without destruction or plastic deformation of either the inner portion 72 or the outer portion 74.

The inner portion 72 comprises a plurality of mating features 76 and the outer portion 74 comprises a plurality of fasteners 78 that engage with the plurality of mating features 76.

The outer portion 74 comprises ribs 80 in the form of a honeycomb pattern, to provide structural reinforcement to the outer portion 74.

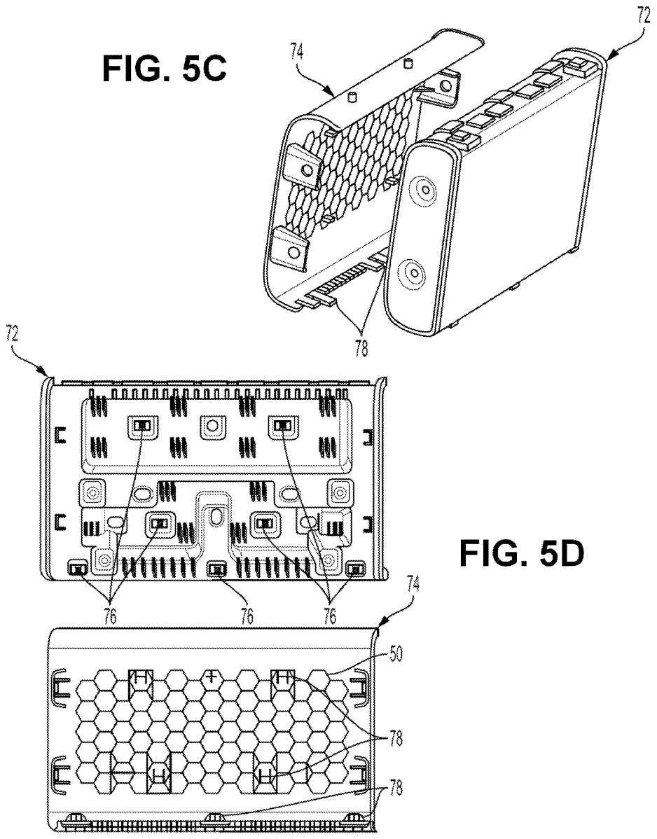

FIG. 6A through FIG. 6C illustrate an exemplary door panel 90, without a trim panel attached. The door panel 90 comprises an inner door panel 92 and an outer door panel 94. The inner door panel 92 includes mating features 96A for storage accessories described herein and mating features 96B for an armrest described herein. In this regard, the inner door panel 92 may provide a rigid mounting interface.

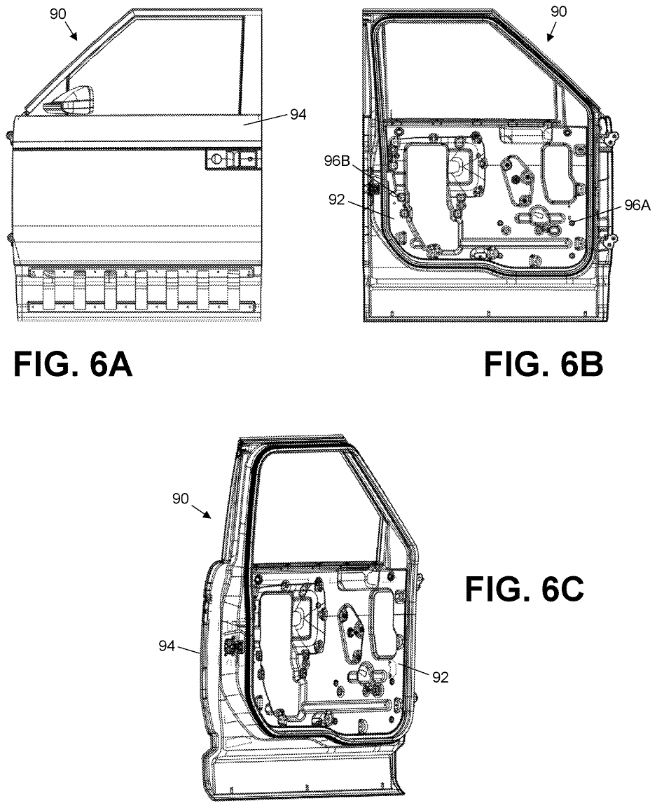

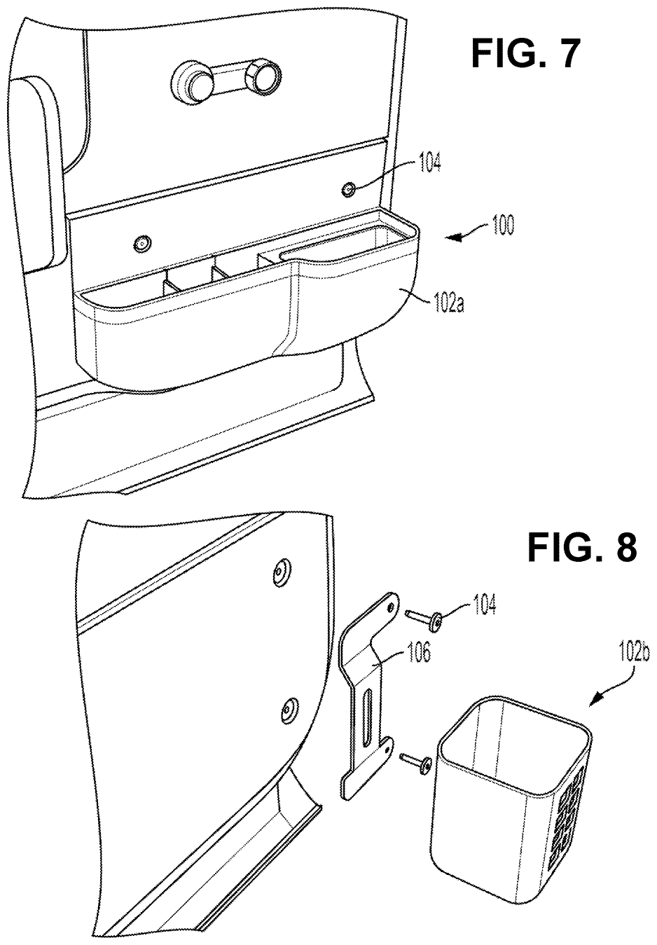

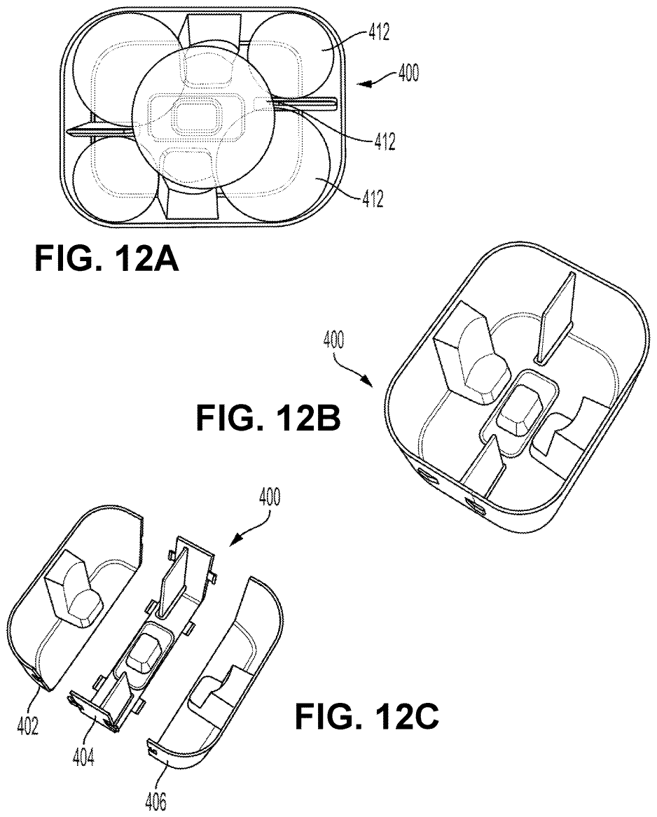

FIG. 7 through FIG. 11B illustrate a door assembly 100 with various examples of storage accessories 102a-102c fastened thereto. FIG. 7 and FIG. 11B illustrate door caddies 102a, 102c. FIG. 8 illustrates a cupholder 102b.

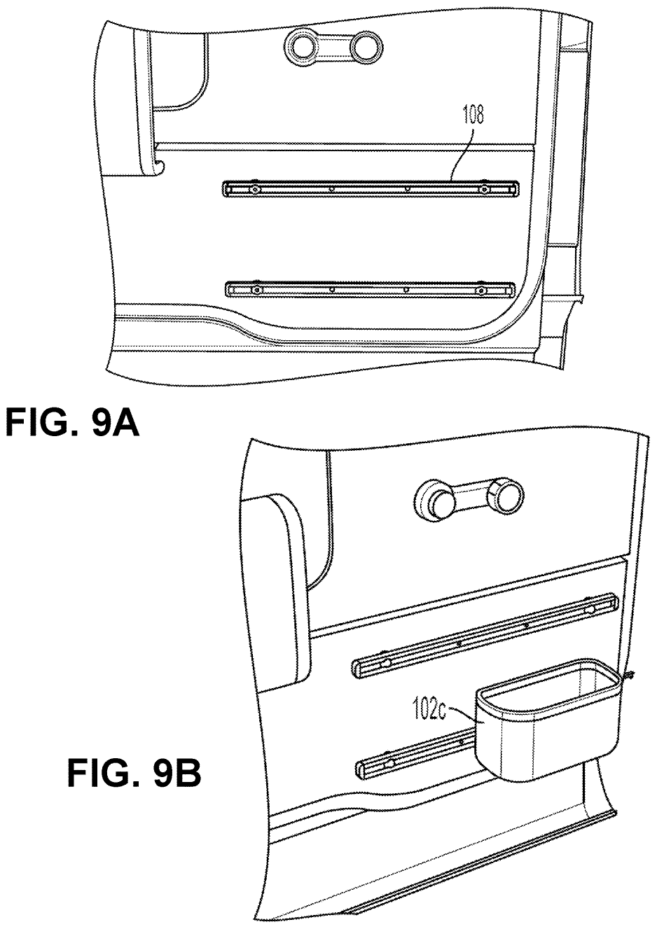

The storage accessories 102a-102-c are ultimately connected to the door assembly 100 via fasteners 104. Preferably, the fasteners 104 extend into the inner door panel. Various mounting arrangements are also contemplated. The fasteners 104 may extend through a storage accessory 102a, through a trim panel, and into an inner door panel (see, e.g., FIG. 7). The fasteners 104 may extend through a bracket 106, through a trim panel, and into an inner door panel, and the storage accessory 102b may be connected to the bracket 106 (see, e.g., FIG. 8). The fasteners 104 may extend through rails 108 (e.g., T-rails), through a trim panel, and into an inner door panel, and the storage accessory 102c may be connected to a rail 108 (see, e.g., FIGS. 9A and 9B).

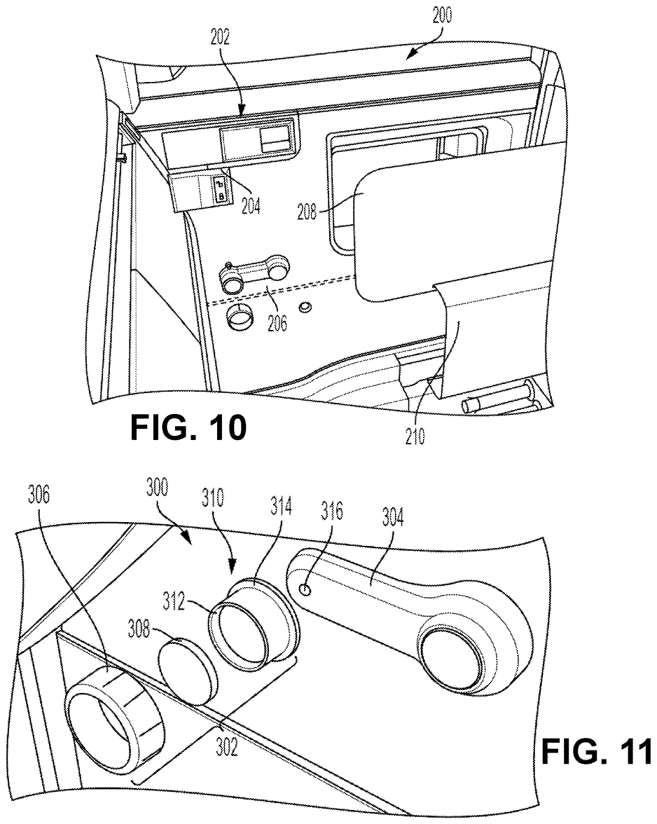

FIG. 10 illustrates a door assembly 200 comprising a door latch and lock assembly 202, where a control module 204 (e.g., comprising automated lock controls, automated window controls, or both) may be applied to the door latch and lock assembly 202. The door assembly 200 further comprises a window crank 206, a bolster 208, and an armrest 210, as described herein.

The door latch and lock assembly 202 can have multiple configurations. In one configuration, a locking function and an unlocking function may be performed by a mechanical system, such as via a toggle on the door latch and lock assembly 202 mechanically changing a state of a lock via one or more linkages between the toggle and the lock. Such functions may only affect the state of the door upon which the door latch and lock assembly 202 is located. In another configuration, a locking function and an unlocking function may be performed by an electronic system, such as via an electronic interface (e.g., mechanical buttons or touch buttons) and an actuator acting upon the lock, where there is signal communication between the electronic interface and the actuator. In this configuration, the mechanical element (e.g., toggle) may also be present. Moreover, in this configuration, the electronic system may cooperatively affect states of locks on two or more doors within the vehicle. Similarly, the control module may be changed with respect to manual or power windows.

The window crank 206 may function as a manual interface to open and close a window on the door assembly 200. In this regard, an occupant may rotate the window crank 206 in a first angular direction to open the window and rotate the window crank 206 in a second, opposing angular direction to close the window. The window crank 206 may be removable from the door assembly 200, and an electronic system for opening and closing the window may be installed. In some aspects, it is contemplated that the electronic system may include an electronic interface (e.g., buttons) on the control module 204 described above for this purpose. Although the present teachings contemplate an electronic interface located elsewhere within the vehicle (e.g., control elements described herein).

FIG. 11 illustrates a window crank 300 with an interchangeable handle 302 that is attachable to a lever 304 thereof. The handle 302 comprises a first segment 306, a second segment 308, and a third segment 310. The third segment 310 includes a colored ring 312, which can be interchanged. The present teachings contemplate that any other element of the window crank 300 can be interchanged, to provide modular design choices. The first segment 306 is locatable over the second and third segments 308, 310, and sandwiches the second segment 308 against the third segment 310. The third segment 310 has a flange 314 against which the first segment 306 engages. The handle 302 is connectable to the lever 304. The handle 302 includes a pin (not shown) that inserts into a hole 316 in the lever 304.

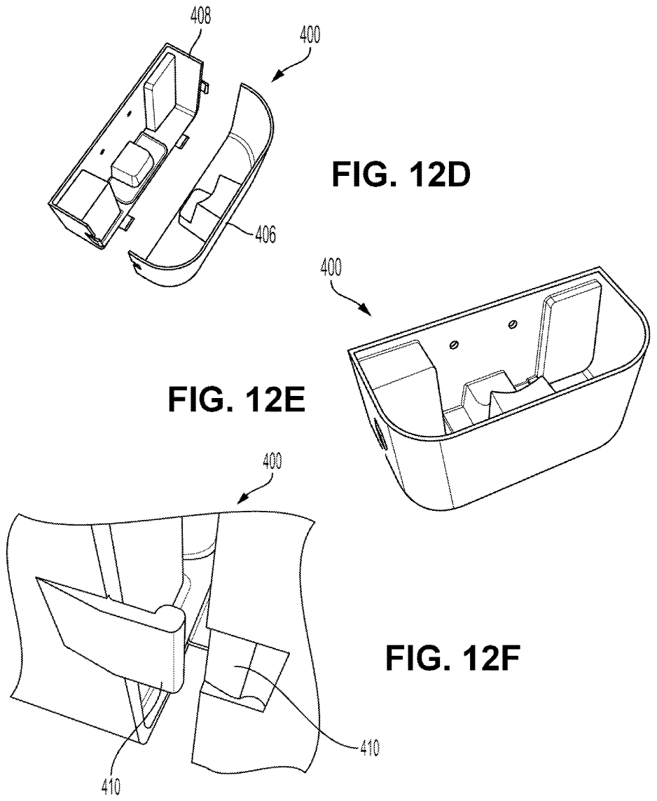

FIG. 12A through FIG. 12F illustrate a cup holder 400, which comprise multiple segments 402, 404, 406, 408 to provide for various configurations. The multiple segments 402, 404, 406, 408 are held together with a snap-fit mechanism 410. The multiple segments 402, 404, 406, 408 cooperate to define receptacles 412.

In one configuration shown in FIG. 12A through FIG. 12C, the first, second, and third segments 702, 704, 706 are in engagement to define five receptacles 412 and form a tray that may be located, for example, in a region between front seats, for example, in a center console region. It can also be seen that the cup holder 400 defines receptacles 412 with three different sizes, to accommodate drinking vessels of various sizes.

In another configuration shown in FIG. 12D and FIG. 12E, the first and fourth segments 402, 408 are in engagement to define two receptacles 412 and form a door caddy that may be located on a door assembly described herein, or a rail connected to the door assembly as described herein. See, e.g., FIG. 7 and FIG. 9B.

Ex.1. One exemplary aspect of the present teachings includes a cup holder. The cup holder may comprise two or more segments.

Ex.1.1. The cup holder may comprise multiple segments. The multiple segments may be separable from each other. The multiple segments may be arranged to connect in multiple different configurations defining one or more receptacles in which a quantity and/or one or more dimensions of the one or more receptacles is different in each of the multiple configurations.

Ex.1.2. The multiple segments may include a first segment, a second segment, and a third segment. The second segment may be located between the first and third segments.

Ex.1.3. The first, second, and third segment may cooperate to define a center console caddy. The center console caddy may comprise a plurality of receptacles. For example, five receptacles.

Ex.1.4. At least three of the receptacles may have a unique cross-sectional dimension. The cross-sectional dimension may be a diameter.

Ex.1.5. The first segment and a fourth segment may cooperate to define a door caddy. The third segment and the fourth segment may cooperate to define a door caddy. The door caddy of the first segment may comprise a plurality of receptacles (e.g., two receptacles). The door caddy of the third segment may comprise a plurality of receptacles (e.g., two receptacles).

Ex.1.6. The multiple segments may connect via a snap-fit connection. The snap-fit connection may comprise a finger and a recess. The finger may have a portion that fits into the recess. The finger may elastically deform in a process of engagement or disengagement of said portion and the recess.

It is understood that the above description is intended to be illustrative and not restrictive. The explanations and illustrations presented herein are intended to acquaint others skilled in the art with the invention, its principles, and its practical application.

Those skilled in the art may adapt and apply the invention in its numerous forms, as may be best suited to the requirements of a particular use. Many embodiments as well as many applications besides the examples provided herein will be apparent to those of skill in the art upon reading the above description.

Accordingly, the specific embodiments of the invention set forth herein are not intended as being exhaustive or limiting of the teachings. The scope of the invention should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The use of “about” or “approximately” in connection with a range applies to both ends of the range. Thus, “about 20 to 30” is intended to cover “about 20 to about 30”, inclusive of at least the specified endpoints.

Unless otherwise stated, all ranges include both endpoints and all numbers between the endpoints in increments of one unit provided that there is a separation of at least 2 units between any lower endpoint and any higher endpoint. As an example, if it is stated that the amount of a component, a property, or a value of a process variable such as, e.g., temperature, pressure, time, and the like is, e.g., from 1 to 90, from 20 to 80, or from 30 to 70, it is intended that intermediate range values such as, e.g., 15 to 85, 22 to 68, 43 to 51, 30 to 32, etc., are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest endpoint and the highest endpoint enumerated are to be considered to be expressly stated in this application in a similar manner.

The term “consisting essentially of” to describe a combination shall include the elements or components identified, and such other elements or components that do not materially affect the basic and novel characteristics of the combination. The use of the terms “comprising” or “including” to describe combinations of elements or components herein also contemplates embodiments that consist essentially of the elements or components.

While the terms first, second, third, etc., may be used herein to describe various elements, components, regions, layers, and/or sections, these elements, components, regions, layers, and/or sections should not be limited by these terms. These terms may be used to distinguish one element, component, region, layer, and/or section from another region, layer, and/or section. Terms such as “first,” “second,” and other numerical terms when used herein do not imply a sequence or order unless clearly indicated by the context. Thus, a first element, component, region, layer, and/or section discussed below could be termed a second element, component, region, layer, and/or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of the device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “generally” or “substantially” to describe angular measurements may mean about +/−10°or less, about +/−5° or less, or even about +/−1° or less. The terms “generally” or “substantially” to describe angular measurements may mean about +/−0.01° or greater, about +/−0.1° or greater, or even about +/−0.5° or greater.

The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

### REFERENCE NUMERALS

10 door assembly
12 inner door panel
14 trim panel
16 bolster
18 armrest
20 window crank
22 door latch and lock assembly
30 trim panel
32 bolster
34 armrest
36 hole (window crank)
38 door latch and lock assembly
40 hole
42 fastener
50 trim panel
52 access hole
54 hole (for bolster)
56 hole (for armrest)
60 bolster
62 concavity
64 stand-off
66 fasteners
70 armrest
72 inner portion
74 outer portion
76 mating feature
78 fastener
80 ribs
90 door panel
92 inner panel
94 outer panel
96A mating feature
96B mating feature
100 door assembly
102a storage accessory
102b storage accessory
102c storage accessory
104 fastener
106 bracket
108 rail
200 door assembly
202 door latch and lock assembly
204 control module
206 window crank
208 bolster
210 armrest
300 window crank
302 handle
304 lever
306 first segment
308 second segment
310 third segment
312 ring
314 flange
316 hole
400 cup holder
402 first segment
404 second segment
406 third segment
408 fourth segment
410 snap-fit mechanism
412 receptacle

What is claimed is:

1. A vehicle door assembly comprising: one or more door panels including at least an inner door panel, a trim panel located on an inner side of the one or more door panels, a bolster, and an armrest;
wherein the armrest and/or the bolster is removable from the trim panel and/or from each other without destruction or plastic deformation of the trim panel, the bolster, and the armrest; wherein the bolster and the armrest cooperate to define a handle; and wherein the bolster comprises one or more stand-offs, preferably two stand-offs, upon which the armrest is supported; and wherein the handle is defined between the bolster, the armrest, and the two stand-offs.

2. The vehicle door assembly according to claim 1, wherein the bolster and the armrest are connected to the trim panel and/or an inner door panel via first fasteners.

3. The vehicle door assembly according to claim 2, wherein the first fasteners include elastically deformable fasteners; and wherein the elastically deformable fasteners include push-in rivet style fasteners, cantilever snap-fit fasteners, or both.

4. The vehicle door assembly according to claim 3, wherein the first fasteners are integrally formed to the bolster, the armrest, or both.

5. The vehicle door assembly according to claim 4, wherein the trim panel, the bolster, the armrest, or any combination thereof are connected to the inner door panel via one or more second fasteners; and wherein the one or more second fasteners include screws, bolts, or both.

6. The vehicle door assembly according to claim 5, wherein the one or more second fasteners are located in a region of the bolster covered by the armrest, in a region of the armrest covered by portion of the armrest, or both.

7. The vehicle door assembly according to claim 1, wherein the handle is in the form of a pull cup.

8. The vehicle door assembly according to claim 7, wherein the bolster includes a depression defined in an A-side of the bolster.

9. The vehicle door assembly according to claim 1, wherein the bolster covers an access opening in the inner door panel of the vehicle door assembly.

10. The vehicle door assembly according to claim 1, wherein the armrest comprises an inner portion and an outer portion; wherein the inner portion connects to the trim panel and/or the inner door panel via the first and/or second fasteners, preferably at least to the inner door panel with at least one of the second fasteners; wherein the outer portion connects to the inner portion via the first fasteners; and wherein the outer portion is removable from the inner portion without destruction or plastic deformation of the inner and outer portions.

11. The vehicle door assembly according to claim 10, wherein the outer portion is defined by a thickness of about 1 millimeters (mm) to about 5 mm, more preferably about 2 mm to about 3 mm.

12. The vehicle door assembly according to claim 11, wherein the outer portion includes one or more ribs; and wherein the one or more ribs are in the form of a honeycomb structure.

13. The vehicle door assembly according to claim 1, wherein the bolster and the armrest are fabricated from a polymer; wherein the polymer includes ABS, nylon, or both; optionally wherein the polymer is fiber reinforced.

14. A vehicle comprising the vehicle door assembly according to claim 1; wherein the vehicle is an electric vehicle; and wherein the vehicle is a reconfigurable vehicle.

15. The vehicle door assembly according to claim 1, further comprising a storage accessory removably connected to the inner door panel, a bracket connected to the inner door panel, or a rail connected to the inner door panel.

16. The vehicle door assembly according to claim 15, wherein the storage accessory is connected to the inner door panel via one or more fasteners; or the bracket is connected to the inner door panel via one or more fasteners; or the rail is connected to the inner door panel via one or more fasteners.

17. The vehicle door assembly according to claim 16, wherein the one or more fasteners pass through the storage accessory, bracket, or rail and through the trim panel and engage the inner door panel; optionally wherein a head of the fastener is exposed.

18. The vehicle door assembly according to claim 17, wherein the inner door panel includes at least four mounting points for said one or more fasteners; wherein the at least four mounting points are arranged in a first row and a second row, wherein the second row is below the first row.

19. The vehicle door assembly according to claim 18, wherein the mounting points in the first row are horizontally aligned and the mounting points in the second row are horizontally aligned; and wherein pairs of mounting points in the first and second rows are vertically aligned.

20. The vehicle door assembly according to claim 19, wherein the one or more storage accessories are in the form of a cup holder or a door caddy.
